(19) United States
(12) Patent Application Publication
(10) Pub. No.: US 2005/0021214 A1
(43) Pub. Date: Jan. 27, 2005

(54) Exhaust component concentration detecting apparatus for internal combustion engine and heating method of exhaust component concentration detector

(75) Inventor: Shigeo Ohkuma, Atsugi-shi (JP)

Correspondence Address: FOLEY AND LARDNER;SUITE 500, 3000 K STREET NW, WASHINGTON, DC, 20007, US

(73) Assignee: HITACHI UNISIA AUTOMOTIVE, LTD.

(21) Appl. No.: 10/895,369

(22) Filed: Jul. 21, 2004

(30) Foreign Application Priority Data
Jul. 23, 2003 (JP) 2003-278479

(51) Int. Cl. G06F 19/00

(52) U.S. Cl. 701/101

(57) ABSTRACT

When a rotation speed of an internal combustion engine is less than a first threshold and also an intake air amount of the internal combustion engine is less than a second threshold, it is judged that a low temperature condition of an exhaust pipe is established, to lower an applied voltage to a heating device of an exhaust component concentration detector equipped in the exhaust pipe, when the low temperature condition continues for a predetermined time or above.

### FIELD OF THE INVENTION

The present invention relates to a technique for heating a detector, which detects the concentration of a specific component in an exhaust gas of an internal combustion engine.

### RELATED ART

Japanese Unexamined Patent Publication No. 09-088688 discloses an air-fuel ratio sensor detecting an air-fuel ratio of an air-fuel mixture based on the oxygen concentration in an exhaust gas.

The air-fuel ratio sensor is heated by a heater, to be kept in an activated condition.

In an internal combustion engine for motorcycle, the engine displacement is small and also the thermal capacity of an exhaust pipe is small, compared with an internal combustion engine for automobile.

Therefore, in the internal combustion engine for motorcycle, the temperature in the exhaust pipe is easy to be varied, and due to a variation of the temperature in the exhaust pipe, condensed water is generated.

If the condensed water hits the air-fuel ratio sensor heated by the heater, sometimes, an element crack occurs due to a thermal shock.

### SUMMARY OF THE INVENTION

The present invention has an object to make it possible to avoid an element crack in an exhaust component concentration detector even in an internal combustion engine of a small engine displacement, which is used for a motorcycle.

In order to achieve the above object, according to the present invention, it is judged whether or not a low temperature condition of an exhaust pipe is established, based on operating conditions of an internal combustion engine, to lower the heating temperature by a heating device, which heats an exhaust component concentration detector, when the low temperature condition of the exhaust pipe is established.

The other objects and features of this invention will become understood from the following description with reference to the accompanying drawings.

### BRIEF EXPLANATION OF THE DRAWINGS

FIG. 1 is a diagram showing a system configuration of an internal combustion engine in an embodiment.

FIG. 2 is a flowchart showing a heater control in the embodiment.

### DESCRIPTION OF EMBODIMENT

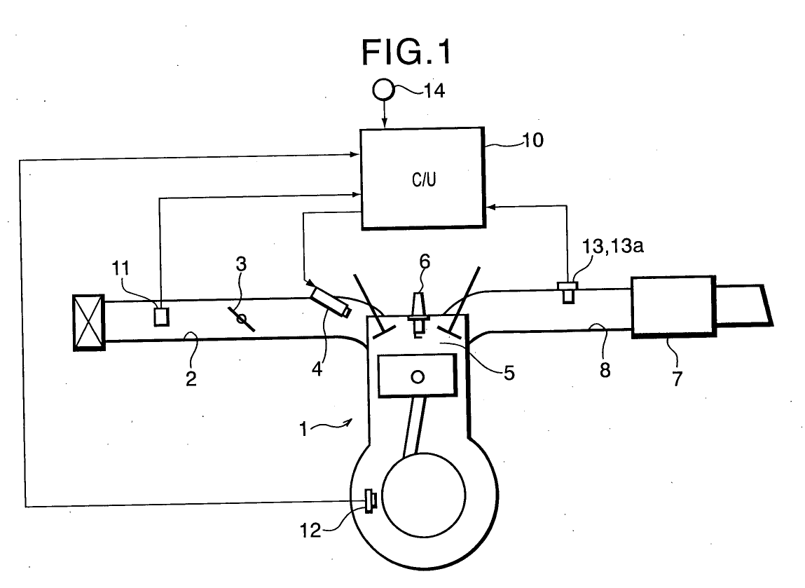

FIG. 1 is diagram showing a system configuration of a single-cylinder internal combustion engine for motorcycle in an embodiment.

In FIG. 1, a throttle valve 3 is disposed in an intake pipe 2 of an internal combustion engine 1.

Throttle valve 3 adjusts an intake air amount of internal combustion engine 1.

A fuel injection valve 4 is disposed in intake pipe 2 on the downstream of throttle valve 3.

In a combustion chamber 5 of internal combustion engine 1, an air-fuel mixture is formed of fuel injected from fuel injection valve 4 and air passed through throttle valve 3.

The air-fuel mixture is ignited to burn in combustion chamber 5, with spark ignition by an ignition plug 6.

Combusted exhaust gas of internal combustion engine 1 is discharged via an exhaust pipe 8, on which is disposed a catalytic converter 7, into the atmosphere.

Fuel injection valve 4 is driven to open according to an injection pulse signal from a control unit 10.

A fuel injection quantity by fuel injection valve 4 is adjusted based on pulse width of the injection pulse signal.

Control unit 10 incorporates therein a microcomputer.

Control unit 10 receives detection signals from various sensors, to output the injection pulse signal by the calculation process based on the detection signals.

As the various sensors, there are provided an air flow meter 11 detecting the intake air amount of internal combustion engine 1 at the upstream side of throttle valve 3, a rotation sensor 12 detecting a rotation speed of internal combustion engine 1, an air-fuel ratio sensor 13 detecting the oxygen concentration inside exhaust pipe 8 on the upstream side of catalytic converter 7, and a vehicle speed sensor 14 detecting a running speed of a motorcycle in which internal combustion engine 1 is installed.

Air-fuel ratio sensor 13 is provided with a heater 13a heating a sensor element.

Note, air-fuel ratio sensor 13 may be the one detecting in a wide range the air-fuel ratio from the oxygen concentration in the exhaust gas, or the one only detecting whether the air-fuel ratio is richer or leaner than a stoichiometric air-fuel ratio.

Here, control unit 10 feedback controls the fuel injection quantity by fuel injection valve 4, so that the air-fuel ratio detected by air-fuel ratio sensor 13 is coincident with the stoichiometiric air-fuel ratio.

Further, control unit 10 controls an applied voltage to heater 13a provided on air-fuel ratio sensor 13.

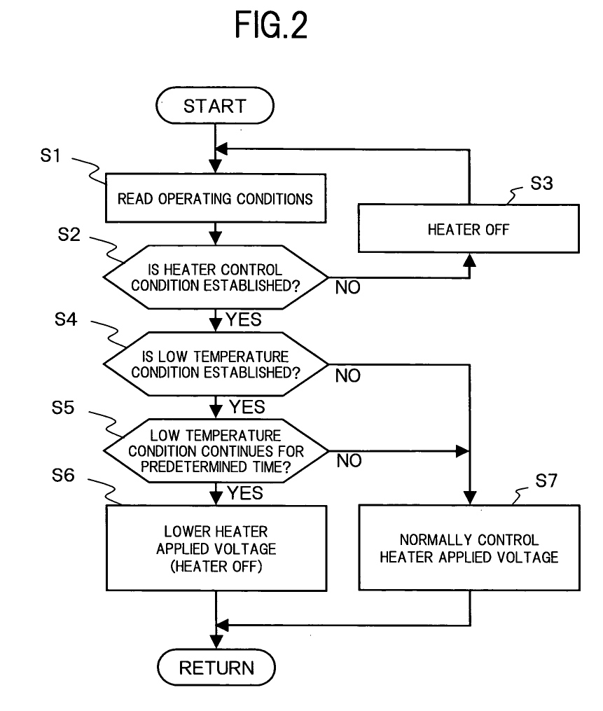

A flowchart of FIG. 2 shows a heater applied voltage control by control unit 10.

In step S1, the vehicle speed, the engine rotation speed, the engine intake air amount and the like, are read.

In step S2, it is judged whether or not a permission condition for a heater control is established.

Here, as the permission condition for the heater control, there are made the judgments that the failures of each component and system are not judged, and that a predetermined time has elapsed after the start of an operation of engine 1.

If the permission condition for the heater control is not established, control proceeds to step S3.

In step S3, the power supply to heater 13a is shut off, and thereafter, control returns to step S1.

On the other hand, if the permission condition for the heater control is established, control proceeds to step S4.

In step S4, it is judged whether or not a low temperature condition of exhaust pipe 8 is established.

Here, it is judged that the low temperature condition of exhaust pipe 8 is established, when the rotation speed of internal combustion engine 1 is less than a first threshold, and also the intake air amount of internal combustion engine 1 is less than a second threshold.

It is also judged that the low temperature condition of exhaust pipe 8 is established, when the vehicle speed exceeds a third threshold.

The rotation speed and intake air amount of the internal combustion engine are data for judging a heat amount of exhaust gas, and the vehicle speed is data for judging a heat radiation amount from exhaust pipe 8.

However, even in a state where the vehicle speed exceeds the third threshold, if the rotation speed of the internal combustion engine exceeds a maximum speed and/or the intake air flow amount of the internal combustion engine exceeds a maximum amount, it is judged that the low temperature condition of exhaust pipe 8 is not established.

Further, it is also possible that the third threshold for the vehicle speed is variably set based on the rotation speed and intake air amount of the internal combustion engine, to judge whether or not the low temperature condition is established, based on the third threshold and the vehicle speed at the time.

In this case, the lower the rotation speed is and the less the intake air amount is, the smaller the third threshold is set, to judge that the low temperature condition of exhaust pipe 8 is established, when an actual vehicle speed exceeds the third threshold.

If the low temperature condition of exhaust pipe 8 is established, control proceeds to step S5.

In step S5, it is judged whether or not the low temperature condition continues for a predetermined time or above.

Here, in the case where the low temperature condition continues for the predetermined time or above, there is a possibility that condensed water is generated due to the temperature drop of exhaust pipe 8, and the condensed water hits an element of air-fuel ratio sensor 13 to cause a thermal shock.

Therefore, in the case where the low temperature condition continues for the predetermined time or above, control proceeds to step S6.

In step S6, an applied voltage to heater 13a is fixed at a previously set low voltage, or the power supply to heater 13a is shut off to lower the heating temperature by heater 13a to be less than the normal temperature.

If the element temperature of air-fuel ratio sensor 13 is lowered, by lowering the applied voltage to heater 13a or shutting off the power supply to heater 13a, the thermal shock of when the condensed water hits the element of air-fuel ratio sensor 13, becomes smaller.

Accordingly, it is possible to avoid an element crack in air-fuel ratio sensor 13 due to the thermal shock, that may occur.

Note, in the case where control proceeds to step S6, an air-fuel ratio feedback control based on the detection signal from air-fuel ratio sensor 13 is stopped or the air-fuel ratio feedback control is performed by making a feedback gain to be small.

On the other hand, when the low temperature condition is not established or when the continuation time of the low temperature condition is less than the predetermined time, control proceeds to step S7.

In step S7, the applied voltage to heater 13a is normally controlled.

In the normal applied voltage control described above, a map storing applied voltages according to an engine load and the engine rotation speed is referred to, and the voltage corresponding to the engine load and rotation speed at the time is applied to heater 13a.

Moreover, the temperature of air-fuel ratio sensor 13 is estimated based on an inner resistance of air-fuel ratio sensor 13, and the applied voltage is feedback controlled based on a deviation between this estimated temperature and the target temperature.

Note, the low temperature condition of exhaust pipe 8 can be judged inclusive of the outside air temperature.

The entire contents of Japanese Patent Application No. 2003-278479 filed on Jul. 23, 2003, a priority of which is claimed, are incorporated herein by reference.

While only a selected embodiment has been chosen to illustrate the present invention, it will be apparent to those skilled in the art from this disclosure that various changes and modifications can be made herein without departing from the scope of the invention as defined in the appended claims.

Furthermore, the foregoing description of the embodiment according to the present invention is provided for illustration only, and not for the purpose of limiting the invention as defined in the appended claims and their equivalents.

1. An exhaust component concentration detecting apparatus for an internal combustion engine, comprising:
a concentration detector, which is equipped in an exhaust pipe of said internal combustion engine, detecting the concentration of a specific component in an exhaust gas;
a heating device heating said concentration detector;
an operating condition detector detecting operating conditions of said internal combustion engine;
a judging device judging whether or not a low temperature condition of said exhaust pipe is established, based on said operating conditions; and
a temperature controller lowering the heating temperature by said heating device, when the low temperature condition of said exhaust pipe is established.

2. An exhaust component concentration detecting apparatus for an internal combustion engine according to claim 1,
wherein said temperature controller lowers the heating temperature by said heating device, when the low temperature condition of said exhaust pipe continues for a predetermined time or above.

3. An exhaust component concentration detecting apparatus for an internal combustion engine according to claim 1,
wherein said operating condition detector detects a rotation speed of said internal combustion engine and an intake air amount of said internal combustion engine.

4. An exhaust component concentration detecting apparatus for an internal combustion engine according to claim 3,
wherein said judging device judges that the low temperature condition of said exhaust pipe is established, when the rotation speed of said internal combustion engine is less than a first threshold and also the intake air amount of said internal combustion engine is less than a second threshold.

5. An exhaust component concentration detecting apparatus for an internal combustion engine according to claim 1,
wherein said operating condition detector detects a running speed of a vehicle in which said internal combustion engine is installed.

6. An exhaust component concentration detecting apparatus for an internal combustion engine according to claim 5,
wherein said judging device judges that the low temperature condition of said exhaust pipe is established, when the running speed of said vehicle is a third threshold or above.

7. An exhaust component concentration detecting apparatus for an internal combustion engine according to claim 1,
wherein said operating condition detector detects a rotation speed of said internal combustion engine, an intake air amount of said internal combustion engine and a running speed of a vehicle in which said internal combustion engine is installed.

8. An exhaust component concentration detecting apparatus for an internal combustion engine according to claim 7,
wherein said judging device judges that the low temperature condition of said exhaust pipe is established, when the running speed of said vehicle is a third threshold or above, and also the rotation speed of said internal combustion engine is a maximum speed or less, and also the intake air amount of said internal combustion engine is a maximum air amount or less.

9. An exhaust component concentration detecting apparatus for an internal combustion engine according to claim 7,
wherein said judging device sets a third threshold based on the rotation speed of said internal combustion engine and the intake air amount of said internal combustion engine, to judge that the low temperature condition of said exhaust pipe is established, when the running speed of said vehicle is the third threshold or above.

10. An exhaust component concentration detecting apparatus for an internal combustion engine according to claim 1,
wherein said temperature controller lowers an applied voltage to said heating device to a previously set voltage, when the low temperature condition of said exhaust pipe is established.

11. An exhaust component concentration detecting apparatus for an internal combustion engine according to claim 1,
wherein said temperature controller shuts off the power supply to said heating device, when the low temperature condition of said exhaust pipe is established.

12. An exhaust component concentration detecting apparatus for an internal combustion engine, comprising:
concentration detecting means equipped in an exhaust pipe of said internal combustion engine, for detecting the concentration of a specific component in an exhaust gas;
heating means for heating said concentration detecting means;
operating condition detecting means for detecting operating conditions of said internal combustion engine;
judging means for judging whether or not a low temperature condition of said exhaust pipe is established, based on said operating conditions; and
temperature control means for lowering the heating temperature by said heating means, when the low temperature condition of said exhaust pipe is established.

13. A heating method for an exhaust component concentration detector, which is equipped in an exhaust pipe of an internal combustion engine to detect the concentration of a specific component in an exhaust gas, and is equipped with a heating device, comprising the steps of:
detecting operating conditions of said internal combustion engine;
judging whether or not a low temperature condition of said exhaust pipe is established, based on said operating conditions of said internal combustion engine; and
lowering the heating temperature by said heating device, when the low temperature condition of said exhaust pipe is established.

14. A heating method for an exhaust component concentration detector according to claim 13,
wherein said step of lowering the heating temperature comprises the steps of:
measuring the continuation time of the low temperature condition of said exhaust pipe; and
lowering the heating temperature by said heating device, when the continuation time of the low temperature condition of said exhaust pipe reaches a predetermined time or above.

15. A heating method for an exhaust component concentration detector according to claim 13,
wherein said step of detecting the operating conditions comprises the steps of:
detecting a rotation speed of said internal combustion engine; and
detecting an intake air amount of said internal combustion engine, and further,
said step of judging whether or not the low temperature condition is established comprises the steps of:
judging whether or not the rotation speed of said internal combustion engine is less than a first threshold;
judging whether or not the intake air amount of said internal combustion engine is less than a second threshold; and
judging that the low temperature condition of said exhaust pipe is established, when the rotation speed of said internal combustion engine is less than the first threshold and also the intake air amount of said internal combustion engine is less than the second threshold.

16. A heating method for an exhaust component concentration detector according to claim 13,
wherein said step of detecting the operating conditions comprises the step of;
detecting a running speed of a vehicle in which said internal combustion engine is installed, and further,
said step of judging whether or not the low temperature condition is established comprises the steps of:
judging whether or not the running speed of said vehicle is a third threshold or above; and
judging that the low temperature condition of said exhaust pipe is established, when the running speed of said vehicle is a third threshold or above.

17. A heating method for an exhaust component concentration detector according to claim 13,
wherein said step of detecting the operating conditions comprises the steps of:
detecting a rotation speed of said internal combustion engine;
detecting an intake air amount of said internal combustion engine; and
detecting a running speed of a vehicle in which said internal combustion engine is installed, and further,
said step of judging whether or not the low temperature condition is established comprises the steps of:
judging whether or not the running speed of said vehicle is a third threshold or above;
judging whether or not the rotation speed of said internal combustion engine is a maximum speed or less;
judging whether or not the intake air amount of said internal combustion engine is a maximum air amount or less; and
judging that the low temperature condition of said exhaust pipe is established, when the running speed of said vehicle is the third threshold or above, and also the rotation speed of said internal combustion engine is the maximum speed or less, and also the intake air amount of said internal combustion engine is the maximum air amount or less.

18. A heating method for an exhaust component concentration detector according to claim 13,
wherein said step of detecting the operating conditions comprises the steps of:
detecting a rotation speed of said internal combustion engine;
detecting an intake air amount of said internal combustion engine; and
detecting a running speed of a vehicle in which said internal combustion engine is installed, and further,
said step of judging whether or not the low temperature condition is established comprises the steps of:
setting a third threshold based on the rotation speed of said internal combustion engine and the intake air amount of said internal combustion engine;
judging whether or not the running speed of said vehicle is the third threshold or above; and
judging that the low temperature condition of said exhaust pipe is established, when the running speed of said vehicle is the third threshold or above.

19. A heating method for an exhaust component concentration detector according to claim 13,
wherein said step of lowering the heating temperature comprises the step of;
lowering an applied voltage to said heating device to a previously set voltage, when the low temperature condition of said exhaust pipe is established.

20. A heating method for an exhaust component concentration detector according to claim 13,
wherein said step of lowering the heating temperature comprises the step of;
shutting off the power supply to said heating device, when the low temperature condition of said exhaust pipe is established.
